(19) United States
(12) Patent Application Publication
(10) Pub. No.: US 2003/0138756 A1
(43) Pub. Date: Jul. 24, 2003

(54) Assortment of teeth and method for preparing teeth

(76) Inventor: Ulrich Monkmeyer, Nierstein (DE)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/203,294

(22) PCT Filed: Feb. 8, 2001
(86) PCT No.: PCT/DE01/00493

(30) Foreign Application Priority Data
Feb. 8, 2000 (DE) 10005354.8

(51) Int. Cl. A61C 13/08; A61C 5/10

(52) U.S. Cl. 433/202.1; 433/223; 264/19

(57) ABSTRACT

An assortment of manufactured teeth are disclosed which are fabricated according to their function and color. The outer dimensions of the teeth, especially in the marginal area, are larger than those of a prepared tooth. The teeth are preferably made of plastic, ceramic or hybrid materials. Adjacent teeth can be interconnected in the manner of a bridge. A method for preparing manufactured teeth is also disclosed in which the fabricated tooth is clamped in a device which virtually correlates the same to the situation of the prepared tooth. The inner fit to the prepared teeth is produced by milling out the lumen. The outer fit is produced by milling down until the preparation limit is reached. A clearance fit with a marginal range of less than 100 μm is preferably provided. A clearance fit with a marginal range of less than 200 μm is preferably provided in the inner area.

### FIELD OF THE INVENTION

The present invention relates to a denture set of fabricatory manufactured teeth fabricated in accordance with function and color, and to a method for preparation of the teeth of the denture set.

### BACKGROUND OF THE INVENTION

The conventional manner of dressing a tooth is to cast the prepared, ground tooth in the oral cavity, in order to fabricate a model. Usually, the model is made of plaster. Until completion of the denture or false teeth, the ground, prepared tooth is dressed with a synthetic provisional solution, i.e. a provisional crown. Therefore, among others the “immediate provisional solution”, a method described by Marxkors in 1983, is applied. In this manner, prefabricated crown sleeves, which are sorted out on the basis of forms and colors, are brought to the prepared tooth by grinding out the clearance fit, filled up with self-polymerizing synthetic material or composites, and placed on the isolated teeth.

After the synthetic material has passed from the plastic into the elastic phase, the second cast and the provisional solution are taken out of the mouth. The unnecessary material is quickly removed with crown scissors. Then, the provisional solution is repeatedly placed onto the pillar teeth and then removed. As soon as the synthetic material begins to become warm and more solid, the synthetic provisional solution is removed and finally hardened in hot water. The preparation border, which becomes visible in the synthetic material, can be marked with a thin pencil. After this, the excesses exceeding the preparation border are removed with a mortiser, and the provisional solution can be fit properly thereon.

After machining and polishing, the integration of the provisional solution is effected with eugenol-free provisional cement. The eugenol freedom allows for later refilling with synthetic material.

The denture or false teeth are then fabricated by the dental technician on the plaster model out of alloys, titanium, ceramic, synthetic material, or the combination of different materials.

Facing crowns have a metallic basis, which is in whole or in part coated with ceramic or synthetic material. The different types of crowns are mostly fabricated by the modelation of the crown in wax on the plaster model.

In accordance with the lost wax method, the wax object is cast in metal. After removing the casting mold from the molding blank, the replacing and adapting on the model stump of the tooth is effected. With this labor-intensive method it is possible to fabricate exactly fitting crowns in the dental laboratory, if each working step has been effected with high precision and in a faultless manner.

However, it cannot always be guaranteed that the crown can also be set on the prepared tooth stump in the oral cavity with the necessary fitting accuracy. Thus, even the smallest inaccuracy in the grinding of the model fabrication and the dental fabrication of the crown can lead to fitting inaccuracies and clinical problems. Insufficient border finish due to insufficient fitting of the crown leads to an accelerated detrition of the fixing material out of the joining slot between the tooth stump and the crown. Thus, expensive remakes are often required in order to fabricate an exactly fitting crown, which is provided with a small enough joining slot and a precise fitting on the ground tooth stump.

To avoid this problem—particularly with respect to the full-ceramic denture or false teeth—the so-called adhesive technique has been developed. In this manner, exact shaping of the inner side of the denture or false teeth sleeve is required. The very exact fitting onto the tooth stump or the preparation of the tooth is effected by a supplementary material, namely a pasty, flowable dental synthetic material, for example a polymeric material, preferably a composite material of applicable consistence and viscosity, which is filled into the inner recess of the denture or false teeth sleeve until the cavity between the dental sleeve and the ground tooth stump is filled conclusively. When setting up and positioning the denture or false teeth sleeve onto the tooth stump, excessive synthetic material will flow from the lower border of the denture or false teeth sleeve and can be removed therefrom. Thus, little of the highly contracting, self-polymerizing synthetic material or composite is used.

These methods require the cooperation of a dentist and a dental laboratory. Furthermore, they have the inconvenience, that the patient has to be provided with a provisory solution, which, in the course of the treatment to be removed and set up, possibly several times. Due to economic or logistic reasons, this method cannot always be employed. The described method of the “immediate care” cannot be used for permanent dentures or false teeth, since the clearance fit is too large and the synthetic material or composite material, which is hardening in the mouth, contracts to too high a degree. Furthermore, the material is esthetically unacceptable due to color divergence.

The hitherto described CAD-CAM procedure for fabrication of dentures or false teeth either fabricates exclusively a sleeve of high-tensile ceramic, which is supplemented by handcrafted work to an anatomic and morphologic crown (e.g. Procera), or they mill or grind the anatomy and morphology of the tooth individually in accordance with the construction by a digital design program (e.g. Cerec).

Traditionally, fabricatory manufactured confection teeth are suited for the “immediate care” method, but not for a definitive denture or false teeth, since its scale in the area of the preparation border is not large enough, and in addition they are particularly palatinally created too small, which leads to the fact that the bulk supplements are not possible in the marginal fitting area are, due to the contracting factor of the composite material.

### SUMMARY OF THE INVENTION

In accordance with the present invention, these and other objects have now been realized by the discovery of a set of fabricated teeth having a predetermined function and color for application to at least one prepared tooth having outer dimensions comprising the fabricated teeth having outer dimensions which are greater than the outer dimensions of the at least one prepared tooth. Preferably, the at least one prepared tooth includes a marginal area, and the outer dimensions of the fabricated teeth are greater than the outer dimensions of the at least one prepared tooth at the marginal area thereof.

In accordance with one embodiment of the fabricated teeth of the present invention, the fabricated teeth comprise a material selected from the group consisting of synthetic, ceramic and hybrid materials.

In accordance with another embodiment of the fabricated teeth of the present invention, the adjacent ones of the fabricated teeth are connected to each other in the form of a bridge.

In accordance with yet another embodiment of the fabricated teeth of the present invention, the fabricated teeth include an outer surface, a predetermined length and a peripheral dimension wherein the fabricated teeth can be adapted to the at least one prepared tooth without perforation of the outer surface thereof.

In accordance with yet another embodiment of the fabricated teeth of the present invention, at least one of the fabricated teeth is prepared from a tooth component such as a natural tooth, a portion of a natural tooth, a natural dental fragment, an in vivo or in vitro cultured natural tooth, an in vivo or in vitro cultured portion of a natural tooth, or an in vivo or in vitro cultured dental fragment.

In accordance with yet another embodiment of the fabricated teeth of the present invention, at least one of the fabricated teeth includes a channel therethrough. Preferably, the channel comprises a palatinal disposed channel. In another embodiment, a plurality of the fabricated teeth include a channel, preferably a palatinal disposed channel. In yet another embodiment, all of the fabricated teeth include such a channel, preferably a palatinal disposed channel.

It is thus an object of the present invention, to create a denture or false teeth as crown, inlay or bridge, which is applicable for the immediate care of patients, which is permanently applicable.

In accordance with the present invention, a method has also been discovered of fabricating a set of fabricated teeth having a predetermined function and color for application to at least one prepared tooth having outer dimensions, the fabricated teeth having an outer dimension which is greater than the outer dimensions of the at least one prepared tooth, the method comprising correlating at least one of the fabricated teeth in a virtual manner, milling the lumen of the at least one prepared tooth in order to fabricate the inside fitting of the at least one prepared tooth and routing the border of the at least one prepared tooth in order to fabricate the outside fitting of the at least one prepared tooth. Preferably, the method includes generating a clearance fit in the marginal area of the at least one prepared tooth, most preferably a clearance fit is less than about 100 μm. In another embodiment, the method includes generating a clearance fit in the inside area of the at least one prepared tooth, and preferably of less than about 20 μm. In yet another embodiment, the method includes fixing a prepared crown to the at least one prepared tooth by means of dental fixing material, and preferably the fixing is carried out using the adhesive technique.

In accordance with the present invention, a set of fabricatory manufactured teeth fabricated in accordance with function and color is proposed, in which the overall sizes of the teeth, particularly in the marginal area, are larger than a prepared tooth.

The teeth of the denture set in accordance with the present invention can be fabricatory pre-manufactured. A complete set of such pre-fabricated teeth can represent all necessary colorations and dental functions. The overall sizes of all teeth, particularly in the marginal area, are larger than the overall sizes of a prepared tooth. This allows for preparing each tooth by a milling process in a manner such that it can be used for the care of a prepared tooth, either as an inlay or as a crown.

The teeth of the dental set in accordance with the present invention are preferably made of synthetic material, ceramic or hybrid materials.

Adjacent teeth of a dental set can also be connected with each other in the sense of a bridge, in order to allow for the immediate care of tooth space.

Preferably, the teeth of the dental set are, with respect to their length and peripheral dimensions, calculated in a manner such that they can be adapted to the prepared teeth without perforation of the outside surface. When preparing the teeth of the dental set, the outside surface of the fabricatory manufactured subject will be preserved. The quality of the fabricatory outside surface is higher than the quality of a processed outside surface, so that a longer durability is warranted and higher esthetic requirements are met.

A denture set in accordance with the present invention can preferably be modified in a way that at least one tooth of the set or several teeth of a natural tooth, a natural tooth part or a natural dental fragment or by an in vitro or in vivo cultured natural tooth, tooth part or dental fragment, is created.

In a preferable process of the denture or false teeth according to the present invention, the teeth are provided with a discharge, which is preferably arranged in the palatinal or lingual area. Thus, an excess of the fixing material can drain off the lumen and is not pressed into the gingival area.

According to the present invention, a method for preparation of fabricatory manufactured teeth of a denture sethas been discovered, which comprises the following steps:

the fabricated tooth is tensed into a device, which correlates it virtually by means of the situation of the prepared tooth;

the inside fitting to the prepared tooth is fabricated by milling of the lumen;

the outside fitting is fabricated by routing the preparation border.

### BRIEF DESCRIPTION OF THE DRAWINGS

The present invention may be more fully appreciated with reference to the following detailed description, which, in turn, refers to the drawings in which:

FIG. 1 is a side, elevational view of a prepared tooth;

FIG. 2 is a side, elevational view of a tooth manufactured in accordance with the traditional manner;

FIG. 3 is a projection of the tooth manufactured in the traditional manner projected over a prepared tooth;

FIG. 4 is a side, elevational view of a modified manufactured tooth projected over the original tooth;

FIG. 5 is a side, elevational view of a manufactured tooth according to the invention projected over the prepared tooth;

FIG. 6 is a side, elevational view showing the area of preparation of the tooth;

FIG. 7 is a side, elevational view of the manufacutred tooth over the prepared tooth; and

FIG. 8 is a side, elevational view of the machined manufactured tooth projected over the prepared tooth.

### DETAILED DESCRIPTION

For performance of the method in accordance with the present invention, the dentist is provided with a set of the teeth of the upper and lower jaws in different sizes and colors. With a digitizing unit he registers the actual situation in the patient's mouth or of a model of the patient's mouth. A fitting tooth is selected. The selection can be effected in a computer assisted manner. The selected tooth is inserted in a milling machine, preferably a CNN milling machine, correlated virtually by means of the situation of the prepared tooth and, according to the axis, ground with a tool, in a manner such that a suitable fitting on the prepared tooth is warranted.

Finally, the crown is set on the tooth stump with its inner recess, whereas the space between the denture or false teeth sleeve and the tooth stump is filled during the—preferably adhesive—fixing with a plastically formable dental material in a manner such that an individual, exactly fitting denture is finally provided, which can be integrated in the denture of the patient with the traditional dental materials and implements.

It is possible to coordinate the teeth of the denture set according to the present invention with minimal joining slot and precise border finish of the denture or false teeth on the tooth stump with the method according to the present invention. Due to the joining slot, which is minimized due to this method, of the intra-oral, adapted denture or false teeth sleeve, a dense, slot-free border finish is warranted after the adhesive pasting/cementing on the restorable tooth.

Preferably a clearance fit is generated in the marginal area of lower than about 100 μm. The clearance fit in the inside area is preferably lower than about 200 μm.

The tooth stump itself can be prepared with the traditional methods for inserting the denture or false teeth, e.g. by a glaze-dentin-adhesion mediator.

In contrast to the prior art, the denture or false teeth in accordance with the present invention describes a decisive improvement with regards to immediate care. Contrary to the well-known solutions, a definite denture or false teeth can be obtained in one process with little economic efforts. The tooth restoration is effected in one treatment session. A provisory care of the prepared tooth until the dental finishing of the denture or false teeth is not applicable. The method can be realized with little technical effort, namely digitizing and a biaxial-CNN machine. Apart from that, only known dental processes are used.

The crown fabricated in accordance with the present invention can be inserted on the tooth stump with traditional methods in analogy for fixing a crown or an inlay or a bridge.

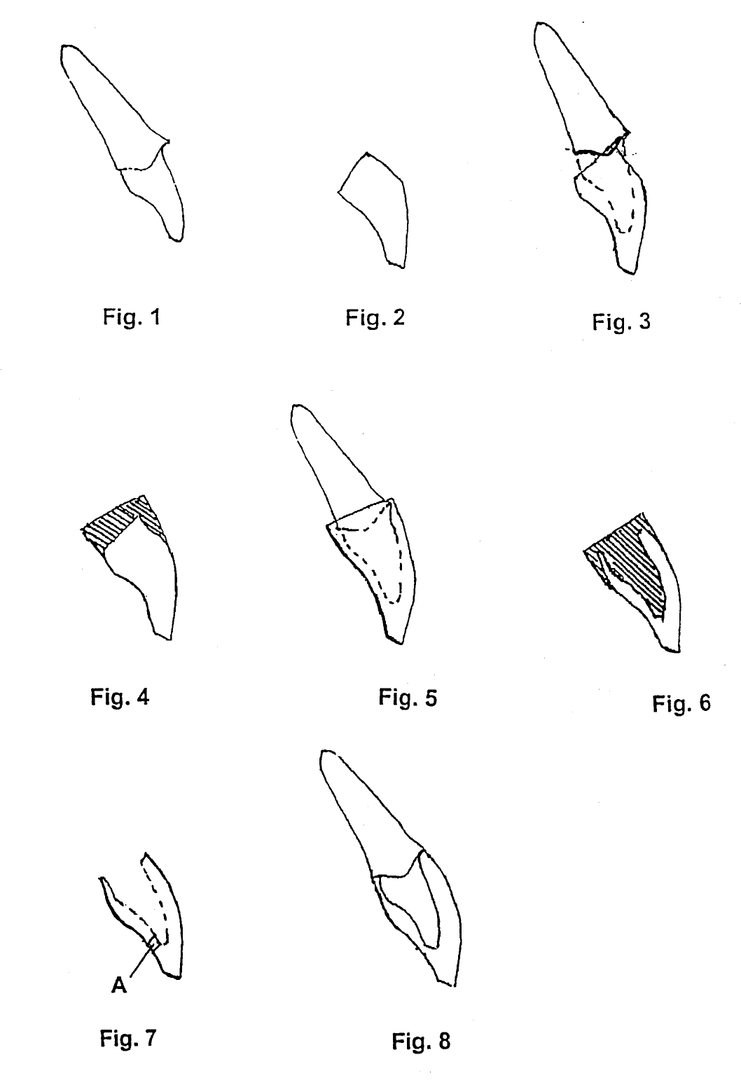

Turning to the drawings, in FIG. 1 the prepared tooth of a patient is shown, which has to be crowned.

FIG. 2 shows a traditional manufactured tooth, which is not suitable for permanent care.

FIG. 3 shows that the manufactured tooth in accordance with FIG. 2, particularly in the marginal area, shows too little dimensions for allowing a total crowning of the prepared tooth. For preparation, the outside surface of the manufactured tooth also has to be perforated, which leads to a lower surface quality in this area.

FIG. 4 shows a tooth according to the present invention of a fabricatory manufactured denture set. In the figure, the tooth according to the present invention is projected over a traditionally fabricated tooth, whereby the modified dimensions are visible in the hatched area.

In FIG. 5 a manufactured tooth according to the present invention is projected over the prepared tooth of the patient. It can be seen that the dimensions of the manufactured tooth are sufficient to allow a permanent crown.

In FIG. 6 is shown the area in which the fabricatory manufactured tooth has to be machined.

FIG. 7 shows the machined result. Additionally, a palatinal discharge A is visible which permits an adhesive material to be drained off and is not pressed into the gingival area.

FIG. 8 shows the machined result projected over the prepared tooth of the patient. It can be seen that a nearly clearance free fitting is reached, which impedes the intrusion of bacteria. The denture or false teeth fabricated in one session is a permanent solution.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A set of fabricatory manufactured teeth, being fabricated in accordance with function and color, characterized in that its outside dimensions are particularly in the marginal area larger than a prepared tooth.

2. Denture set in accordance with claim 1, characterized in that the teeth are made of synthetic material, ceramic or hybrid material

3. Denture set in accordance with claim 1 or 2, characterized in that adjacent teeth are connected with each other in the sense of a bridge.

4. Denture set in accordance with one of the claims 1 to 3, characterized in that the teeth are, with respect to their length and periphery dimensions, measured in a way, that they can be adapted to the prepared teeth without perforation of the outside surface.

5. Denture set in accordance with one of the claims 1 to 4, characterized in that at least one tooth of the set is created by a natural tooth, a natural tooth part or a natural dental fragment or by an in vitro or in vivo cultured natural tooth respectively tooth part or dental fragment.

6. Denture set in accordance with one of the claims 1 to 5, characterized in that in one, plural or all teeth of the denture set a channel (A), preferably in palatinal arrangement, is provided.

7. Method for preparation of fabricatory manufactured teeth of a denture set in accordance with one of the claims 1 to 6 with the following steps:
the manufactured tooth is tensed into a device, which correlates it virtually via the situation of the prepared tooth;
the inside fitting to the prepared tooth is fabricated by milling of the lumen;
the outside fitting is fabricated by routing to the preparation border.

8. Method in accordance with claim 7, characterized in that a clearance fit can be generated in the marginal area, which is lower than 100 μm.

9. Method in accordance with claim 7 or 8, characterized in that a clearance fit of lower than 200 μm is generated in the inside area.

10. Method in accordance with one of the claims 8 to 9, characterized in that the prepared sleeve crown is fixed by a dental fixing material, preferably in accordance with the adhesive technique.
